(19) United States
(12) Patent Application Publication
(10) Pub. No.: US 2012/0326978 A1
(43) Pub. Date: Dec. 27, 2012

(54) CURSOR CONTROL APPARATUS, CURSOR CONTROL METHOD, AND STORAGE MEDIUM FOR STORING CURSOR CONTROL PROGRAM

(75) Inventor: Shinobu TOKITA, Kawasaki (JP)

(73) Assignee: FUJITSU LIMITED, Kawasaki-shi (JP)

(21) Appl. No.: 13/454,174

(22) Filed: Apr. 24, 2012

(30) Foreign Application Priority Data
Jun. 24, 2011 (JP) 2011-141239

(51) Int. Cl. G06F 3/033; G06F 3/041

(52) U.S. Cl. 345/157

(57) ABSTRACT

A apparatus which manages a virtual-coordinate space including a first and a second display area, the apparatus includes a memory that stores a display coordinate at which a cursor is displayed, the display coordinate being defined in the virtual-coordinate space, and a processor that executes a process including acquiring a touched coordinate at which a touch panel on the first display area is touched, calculating a displacement vector of the touched coordinate, identifying which is a display area displaying the cursor among the first and the second display areas, and updating the display coordinate with a coordinate corresponding to the touched coordinate when the cursor is determined to be displayed in the first display area, and updating the display coordinate with a coordinate displaced from the display coordinate stored in the memory using the displacement vector when the cursor is determined to be displayed in the second display area.

### CROSS-REFERENCE TO RELATED APPLICATION

This application is based upon and claims the benefit of priority of the prior Japanese Patent Application No. 2011-141239, filed on Jun. 24, 2011, the entire contents of which is incorporated herein by reference.

### FIELD

The embodiments discussed herein are related to a cursor control apparatus, a cursor control method, and a storage medium for storing a cursor control program.

### BACKGROUND

For example, a so-called multidisplay system is known in the related art in which a plurality of displays are connected to a personal computer, and the display area of the personal computer is divided for the individual displays.

Japanese Laid-open Patent Publication No. 2007-156156 discusses a multidisplay system in which a personal computer displays a cursor (or a pointer or a mouse cursor) on either an internal display or an external display on the basis of input information from, for example, a mouse and a touch pad.

Some recent personal computers have a touch panel on an internal display and display a cursor on the internal display on the basis of detected coordinates on the touch panel.

However, because the present personal computers display the cursor directly under a fingertip in contact with the touch panel, the cursor is not displayed in a display area of an external display having no touch pad. That is, with the multidisplay system, a cursor operation using a touch panel is not performed in the display area of the external display. Accordingly, for example, an external mouse is connected to perform a cursor operation in the display area of the external display.

### SUMMARY

According to an aspect of the invention, a cursor control apparatus which manages a virtual-coordinate space including a first display area of a first display and a second display area of a second display continuous with each other and which displays a cursor on either of the first display area and the second display area, the cursor control apparatus includes a memory that stores a display coordinate at which the cursor is displayed, the display coordinate being defined in the virtual-coordinate space, and a processor that executes a process including acquiring a touched coordinate at which a touch panel on the first display area is touched, calculating a displacement vector of the touched coordinate, identifying which is a display area displaying the cursor among the first display area and the second display area, and updating the display coordinate with a coordinate corresponding to the touched coordinate when the cursor is determined to be displayed in the first display area, and updating the display coordinate with a coordinate displaced from the display coordinate stored in the memory using the displacement vector when the cursor is determined to be displayed in the second display area.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a hardware configuration diagram of a personal computer and an external display according to a first embodiment;

FIG. 2 is a schematic diagram of an OS, a device driver for a touch panel, a device driver for an internal display, and a device driver for the external display, which are loaded in a main memory, according to the first embodiment;

FIG. 3 is a schematic diagram of first and second determination processes for determining the display coordinates of a cursor according to the first embodiment;

FIG. 4 is a diagram illustrating a functional block 1 for cursor control according to the first embodiment;

FIG. 5 is a flowchart for the first determination process for determining internal coordinates according to the first embodiment;

FIG. 6 is a diagram illustrating a functional block 2 for cursor control according to the first embodiment;

FIG. 7 is a diagram schematically illustrating the internal display and the external display;

FIG. 8 is a flowchart for a second determination process for determining the display coordinates of the cursor according to the first embodiment (part 1);

FIG. 9 is a flowchart for the second determination process for determining the display coordinates of the cursor according to the first embodiment (part 1);

FIGS. 10A and 10B are explanatory diagrams illustrating an operation for displaying the cursor according to the first embodiment;

FIGS. 11A and 11B are explanatory diagrams illustrating an operation for moving the cursor according to the first embodiment;

FIG. 12 is a diagram illustrating a functional block for cursor control according to a second embodiment;

FIG. 13 is a flowchart for a first determination process for determining internal coordinates according to the second embodiment;

FIGS. 14A and 14B are explanatory diagrams illustrating the operation of displaying the cursor according to the second embodiment; and

FIGS. 15A and 15B are explanatory diagrams illustrating the operation of moving the cursor according to the second embodiment.

### DESCRIPTION OF EMBODIMENTS

### First Embodiment

A first embodiment will be described hereinbelow.

Hardware Configuration

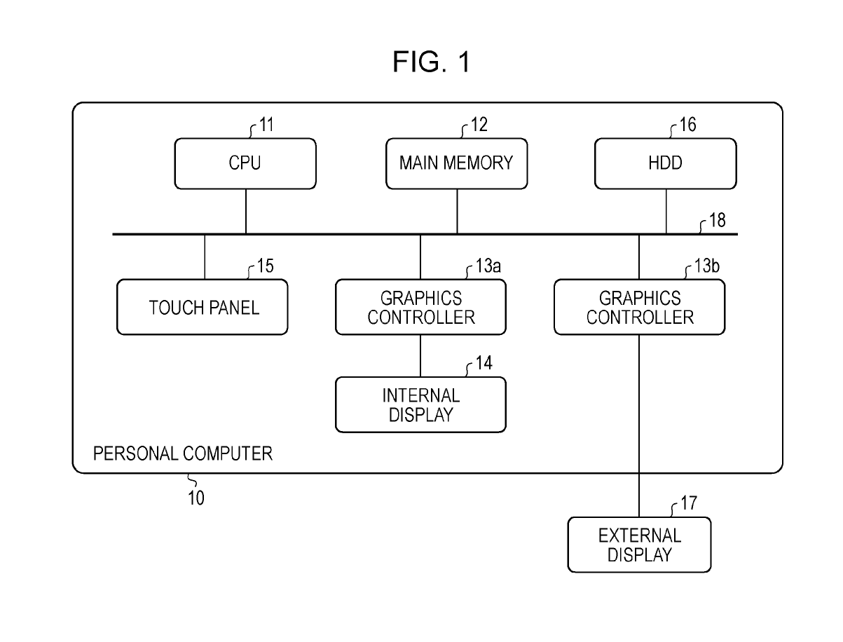

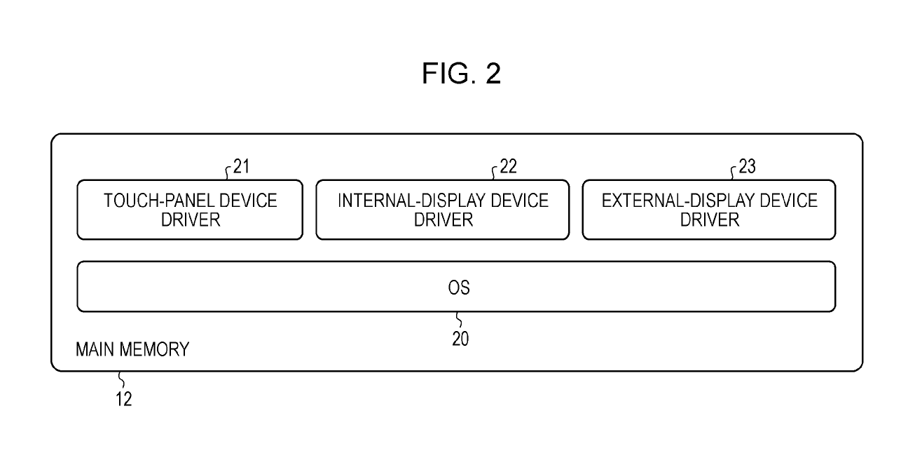

Referring to FIGS. 1 and 2, the hardware configuration of a personal computer 10 and an external display 17 according to the first embodiment will be described.

FIG. 1 is a hardware configuration diagram of the personal computer 10 and the external display 17 according to the first embodiment. FIG. 2 is a schematic diagram of an operating system 20 (hereinafter referred to as an OS 20), a device driver 21 for a touch panel 15, a device driver 22 for an internal display 14, and a device driver 23 for the external display 17, which are loaded in a main memory 12, according to the first embodiment.

As illustrated in FIG. 1, the personal computer 10 mainly includes a central processing unit 11 (hereinafter referred to as a CPU 11), the main memory 12, graphics controllers 13a and 13b, the internal display 14, the touch panel 15, and a hard disk drive 16 (hereinafter referred to as a HDD 16).

The CPU 11, the main memory 12, the graphics controllers 13a and 13b, the touch panel 15, and the HDD 16 are connected by a bus 18. The internal display 14 is connected to the graphics controller 13a, and the external display 17 is connected to the graphics controller 13b.

The CPU 11 controls the operation of the personal computer 10 and, as illustrated in FIG. 2, executes various processes of the first embodiment on the basis of various programs loaded from the HDD 16 into the main memory 12, such as the OS 20, the device driver 21 for the touch panel 15, the device driver 22 for the internal display 14, and the device driver 23 for the external display 17.

The main memory 11 stores various programs, such as the OS 20 and the device drivers 21, 22, and 23. The main memory 11 functions as first, second, third, and fourth storage sections 107, 108, 109, and 115, as will be described later. The details of the individual storage sections 107, 108, 109, and 115 will be described later.

The graphics controller 13a outputs image data to the internal display 14 in accordance with an instruction from the CPU 11. The graphics controller 13b outputs image data to the external display 17 in accordance with an instruction from the CPU 11. The graphics controllers 13a and 13b may be installed in the CPU 11. Alternatively, the graphics controller 13b may be added to the personal computer 10 externally with a USB or the like.

The internal display 14 is installed in the personal computer 10. The external display 17 is detachably connected to the personal computer 10. The screen sizes and resolutions of the internal display 14 and the external display 17 are not particularly limited.

The touch panel 15 is affixed to the display screen of the internal display 14. The touch panel 15 acquires, for example, the contact position of a user's fingertip as detected coordinates (Xp, Yp). A detecting operation via the touch panel 15 is executed certain intervals on the basis of the device driver 21. Accordingly, for example, when a fingertip in contact with the touch panel 15 is moved, a plurality of detected coordinates (Xp, Yp) on the path of contact are continuously acquired.

The HDD 16 stores various programs, such as the OS 20 and the device drivers 21, 22, and 23. The HDD 16 also stores the minimum coordinates (Xmin, Ymin) and maximum coordinates (Xmax, Ymax) of each of the internal display 14 and the external display 17. The details of the minimum coordinates and the maximum coordinates will be described later.

Coordinate Determination Process

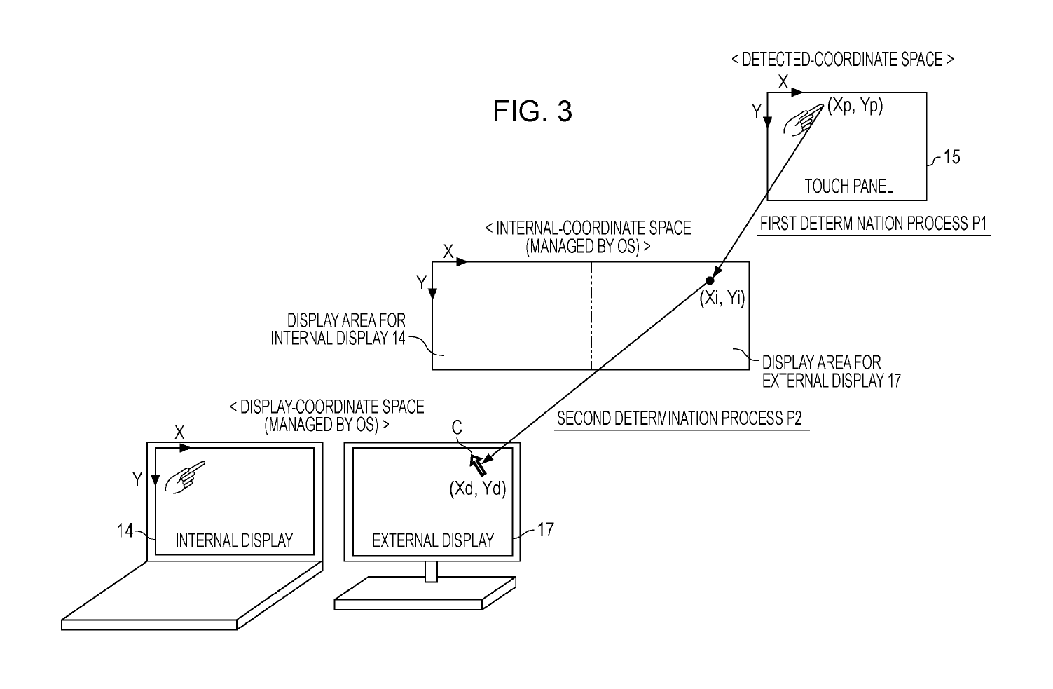

Referring to FIG. 3, a process for determining the coordinates of a cursor C according to the first embodiment will be described.

FIG. 3 is a schematic diagram of first and second determination processes P1 and P2 for determining the display coordinates (Xd, Yd) of the cursor C according to the first embodiment.

As illustrated in FIG. 3, in the process of determining the coordinates of the cursor C according to the first embodiment, first, internal coordinates (Xi, Yi) for use in internal processing of the personal computer 10 are determined on the basis of the detected coordinates (Xp, Yp) acquired from the touch panel 15 (a first determination process P1). Subsequently, display coordinates (Xd, Yd) for actually displaying the cursor C are determined on the basis of the internal coordinates (Xi, Yi) determined by the first determination process P1 (a second determination process P2). The details of the first and second determination processes P1 and P2 will be described later.

In the following description, a set of the detected coordinates (Xp, Yp) acquired from the touch panel 15 is a detected-coordinate space, a positive direction on the X-axis defined in the detected-coordinate space is right, a positive direction on the Y-axis is below, and the origin is the upper left corner of the touch panel 15.

A set of internal coordinates (Xi, Yi) determined by the first determination process P1 is an internal-coordinate space (virtual-coordinate space) managed by the OS 20, a positive direction on the X-axis defined in the internal-coordinate space is right, and a positive direction on the Y-axis is below, and the origin is the upper left corner of the internal-coordinate space.

A set of display coordinates (Xd, Yd) determined by the second determination process P2 is a display-coordinate space (virtual-coordinate space) managed by the OS 20, a positive direction on the X-axis defined in the display-coordinate space is right, a positive direction on the Y-axis is below, and the origin is the left upper corner of the display-coordinate space.

Functional Block 1 for Cursor Control

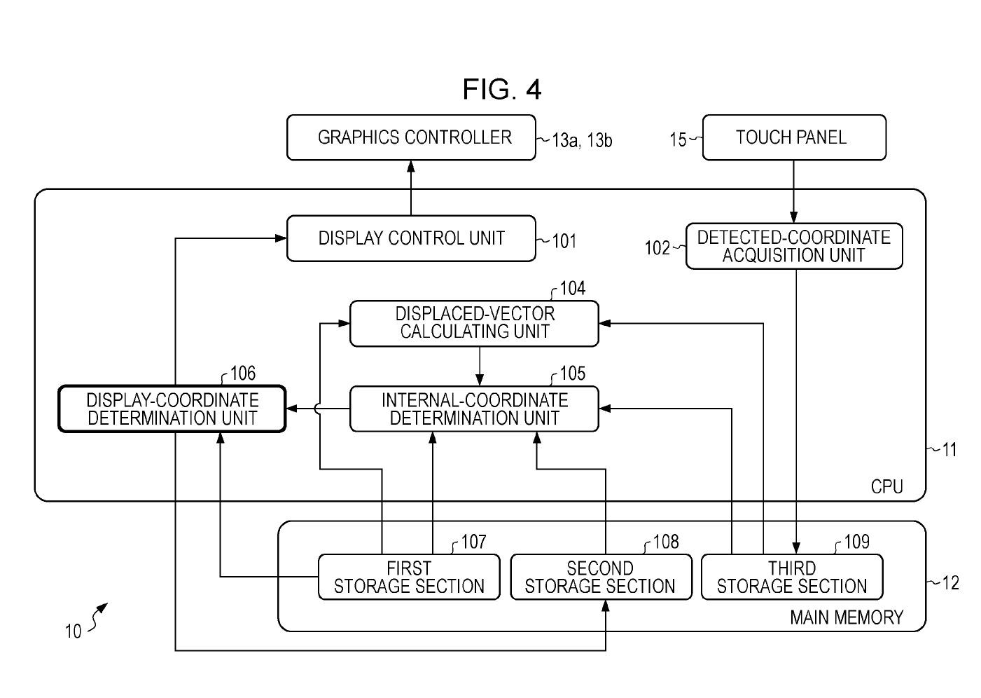

Referring to FIG. 4, a functional block 1 for determining the internal coordinates (Xi, Yi) on the basis of the detected coordinates (Xp, Yp) acquired from the touch panel 15 will be described.

FIG. 4 is a functional block diagram of cursor control according to the first embodiment.

As illustrated in FIG. 4, the personal computer 10 includes a display control unit 101, a detected-coordinate acquisition unit 102, a displacement-vector calculating unit 104, an internal-coordinate determination unit 105, a display-coordinate determination unit 106, a first storage section 107, a second storage section 108, and a third storage section 109.

The display control unit 101 manages the display areas of the internal display 14 and the external display 17 as a continuous virtual-coordinate space. The virtual-coordinate space is defined by the X-axis and the Y-axis perpendicular to each other. Accordingly, points in the display areas of the internal display 14 and the external display 17 are associated with some internal coordinates (Xi, Yi) in the virtual-coordinate space.

Furthermore, the display control unit 101 notifies the graphics controller 13a or 13b of the display coordinates (Xd, Yd) determined by the display-coordinate determination unit 106 to display the cursor C on either of the internal display 14 and the external display 17. For example, if the display coordinates (Xd, Yd) are in the coordinate range of the internal display 14, the display control unit 101 notifies the graphics controller 13a of the display coordinates (Xd, Yd) to display the cursor C on the internal display 14. On the other hand, if the display coordinates (Xd, Yd) are in the coordinate range of the external display 17, the display control unit 101 notifies the graphics controller 13b of the display coordinates (Xd, Yd) to display the cursor C on the external display 17.

The detected-coordinate acquisition unit 102 acquires detected coordinates (Xp, Yp) detected at certain intervals on the touch panel 15 and stores the detected coordinates (Xp, Yp) in the third storage section 109 in association with the respective detection times.

The displacement-vector calculating unit 104 calculates the displacement vector V of the detected coordinates (Xp, Yp) on the basis of the detected coordinates (Xp, Yp) stored in the third storage section 109. The displacement vector V corresponds to the movement vector of, for example, a user's fingertip in contact with the surface of the touch panel 15.

Although the displacement-vector calculating unit 104 according to the first embodiment calculates the displacement vector V on the basis of the detected coordinates (Xp, Yp), the displacement-vector calculating unit 104 may calculate the displacement vector V on the basis of, for example, the internal coordinates (Xi, Yi).

Although the displacement-vector calculating unit 104 according to the first embodiment calculates the displacement vector V only when a CD value, which is identification information, stored in the first storage section 107 is “1”, that is, only when the cursor C is displayed on the external display 17, the displacement-vector calculating unit 104 may similarly calculate the displacement vector V, for example, when the CD value is “0”, that is, when the cursor C is displayed on the internal display 14.

The internal-coordinate determination unit 105 determines the internal coordinates (Xi, Yi) on the basis of the CD value stored in the first storage section 107 with reference to any of the latest detected coordinates (Xp, Yp) stored in the third storage section 109, the display coordinates (Xd, Yd) stored in the second storage section 108, and the displacement vector V calculated by the displacement-vector calculating unit 104.

Although the details will be described later, if CD=0, the latest detected coordinates (Xp, Yp) stored in the third storage section 109 are referred to. If CD=1, the display coordinates (Xd, Yd) stored in the second storage section 107 and the displacement vector V calculated by the displacement-vector calculating unit 104 are referred to.

The display-coordinate determination unit 106 determines the display coordinates (Xd, Yd) of the cursor C on the basis of the CD value stored in the first storage section 107 and the internal coordinates (Xi, Yi) determined by the internal-coordinate determination unit 105. The details of the display-coordinate determination unit 106 will be described later. The display-coordinate determination unit 106 constitutes a determination section that determines the display coordinates (Xd, Yd) of the cursor C on the basis of the input information and the identification information on the touch panel 15, together with the internal-coordinate determination unit 105.

The first storage section 107 stores the CD value that identifies a display on which the cursor C is displayed out of the internal display 14 and the external display 17. The CD value (=Current Disp.) is “0” or “1”. Each of the values is assigned to corresponding one of the individual internal display 14 and the external display 17. In the first embodiment, “0” is assigned to the internal display 14, and “1” is assigned to the external display 17. Accordingly, when the cursor C has moved from the internal display 14 to the external display 17 and when the cursor C has moved from the external display 17 to the internal display 14, the CD value is rewritten.

The second storage section 108 stores the latest display coordinates (Xd, Yd) of the cursor C determined by the display-coordinate determination unit 106. Note, however, that the second storage section 108 may store not only the latest display coordinates (Xd, Yd) of the cursor C but also a plurality of display coordinates (Xd, Yd) determined by the display-coordinate determination unit 106 in association with the individual determination times.

The third storage section 109 stores the detected coordinates (Xp, Yp) acquired by the detected-coordinate acquisition unit 102 in association with the individual determination times.

The display control unit 101, the detected-coordinate acquisition unit 102, the displacement-vector calculating unit 104, the internal-coordinate determination unit 105, and the display-coordinate determination unit 106 are individually implemented by the CPU 11 on the basis of the OS 20 and the device drivers 21, 22, and 23 loaded in the main memory 12. The first storage section 107, the second storage section 108, and the third storage section 109 are constituted in the main memory 12.

First Determination Process P1

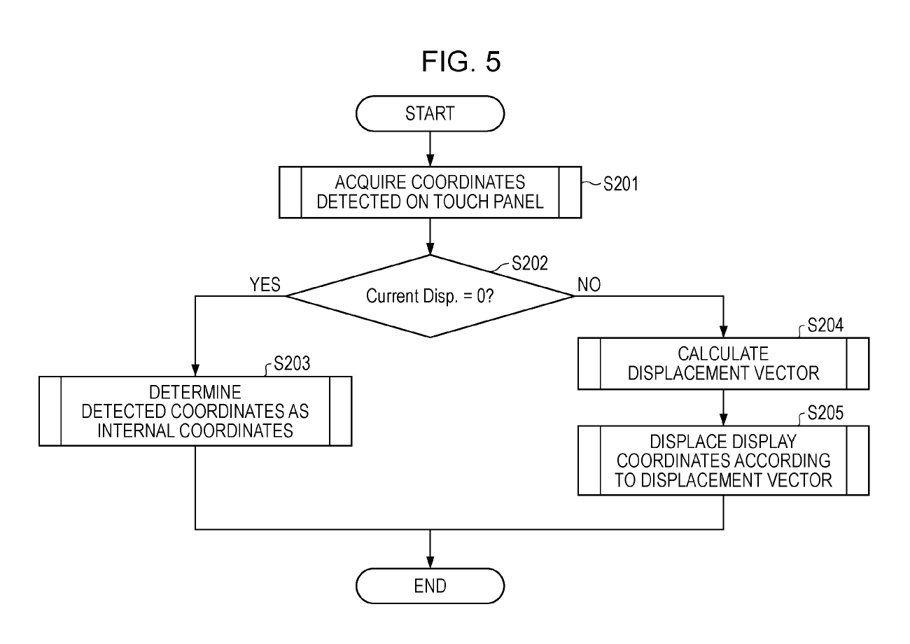

Referring to FIG. 5, the first determination process P1 for determining the internal coordinates (Xi, Yi) on the basis of the detected coordinates (Xp, Yp) acquired from the touch panel 15 will be described.

FIG. 5 is a flowchart for the first determination process P1 for determining the internal coordinates (Xi, Yi) according to the first embodiment.

For example, when the cursor C is operated to cause an interrupt or the like, the first process P1 for determining the internal-coordinates (Xi, Yi) is started, as illustrated in FIG. 5.

When the first determination process P1 is started, the detected-coordinate acquisition unit 102 starts acquisition of the detected coordinates (Xp, Yp) detected on the touch panel 15 (step S201). The detected coordinates (Xi, Yi) acquired by the detected-coordinate acquisition unit 102 are stored in the third storage section 109 one after another.

Next, the internal-coordinate determination unit 105 determines whether the CD value stored in the first storage section 107 is “0” or “1” (step S202).

If the CD value is “0” (Yes in step S202), the internal-coordinate determination unit 105 determines the latest detected coordinates (Xp, Yp) stored in the third storage section 109 as the internal coordinates (Xi, Yi) (step S203). Thus, the first determination process P1 concludes.

If the CD value is “1” (No in step S202), the displacement-vector calculating unit 104 calculates the displacement vector V of the detected coordinates (Xp, Yp) on the basis of the latest detected coordinates (Xp, Yp) stored in the third storage section 109 and detected coordinates (Xp′, Yp′) stored before (step S204).

Next, the internal-coordinate determination unit 105 displaces the display coordinates (Xd, Yd) of the cursor C stored in the second storage section 108 according to the displacement vector V and determines the coordinates as the internal coordinates (Xi, Yi) of the cursor C (step S205). Thus, the first determination process P1 concludes.

Although the displacement-vector calculating unit 104 according to the first embodiment calculates the displacement vector V only when the CD value is “1”, the displacement-vector calculating unit 104 may calculate the displacement vector V also when the CD value is “0”.

Functional Block 2 for Cursor Control

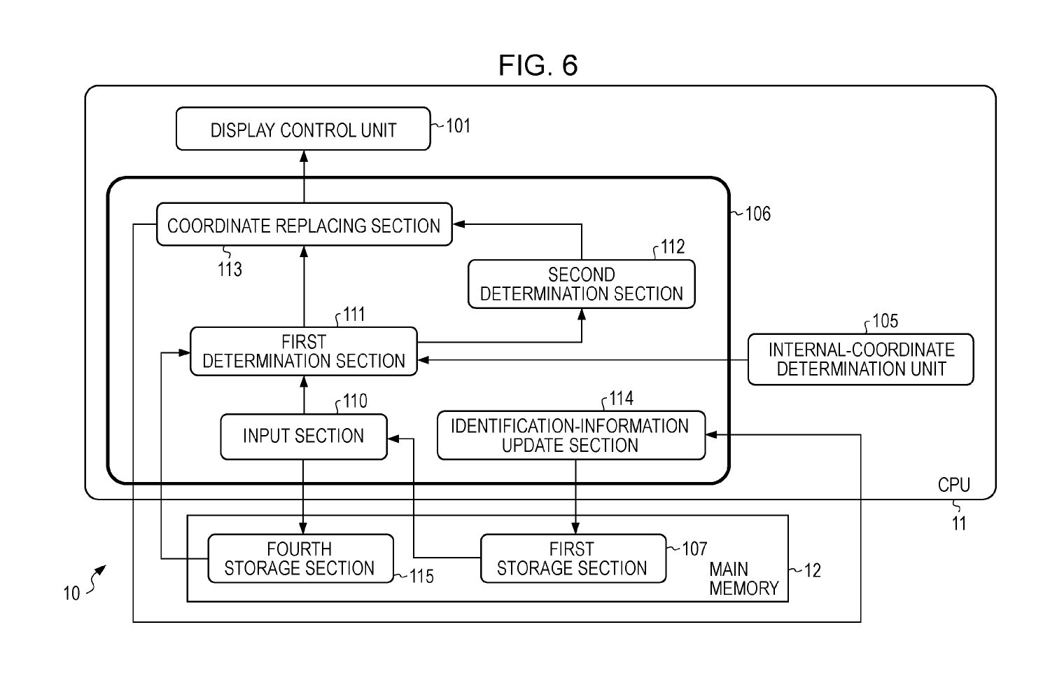

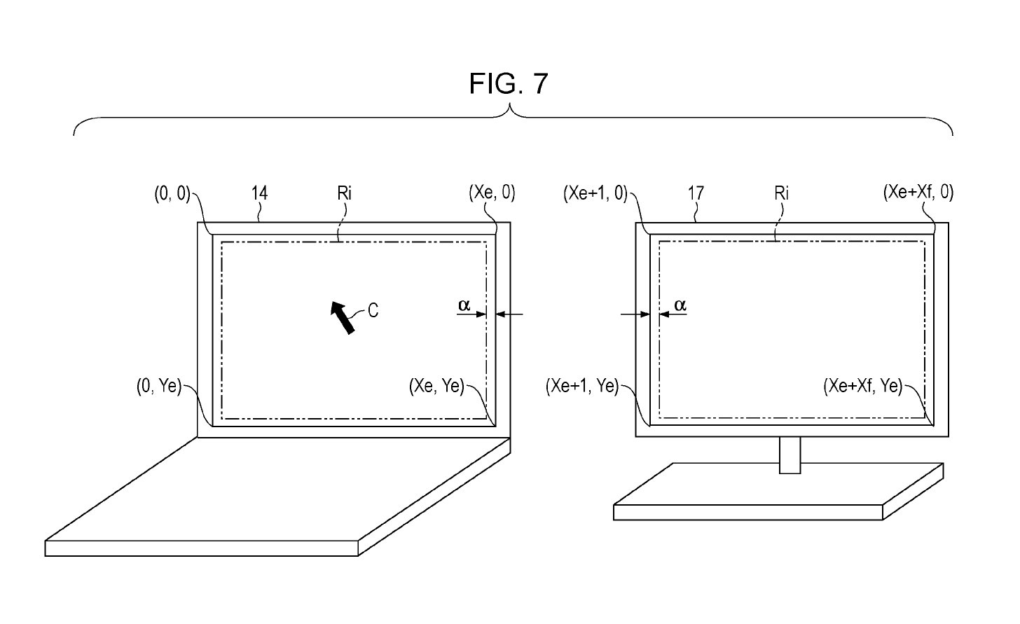

Referring to FIGS. 6 and 7, a functional block 2 for determining the display coordinates (Xd, Yd) of the cursor C on the basis of the internal coordinates (Xi, Yi) determined by the first determination process P1 will be described.

FIG. 6 is a functional block diagram of cursor control according to the first embodiment. FIG. 7 is a diagram schematically illustrating the internal display 14 and the external display 17.

As illustrated in FIG. 6, the personal computer 10 further includes an input section 110, a first determination section 111, a second determination section 112, a coordinate replacing section 113, and an identification-information update section 114.

The input section 110 inputs minimum coordinates (Xmin, Ymin) and maximum coordinates (Xmax, Ymax) of a display on which the cursor C is displayed, that is, either of the internal display 14 and the external display 17, on the basis of the CD value stored in the first storage section 107.

The minimum coordinates (Xmin, Ymin) and the maximum coordinates (Xmax, Ymax) are defined for the display-coordinate space managed by the OS 20 and are stored in, for example, the HDD 16.

As illustrated in FIG. 7, in the first embodiment, the minimum coordinates Xmin and Ymin of the internal display 14 are “0” and “0”, respectively, and the maximum coordinates Xmax and Ymax are “Xe” and “Ye”, respectively. Accordingly, if CD=0, “0” and “0” are input as the minimum coordinates Xmin and Ymin, respectively, and “Xe” and “Ye” are input as the maximum coordinates Xmax and Ymax, respectively. If CD=1, “Xe+1” and “0” are input as the minimum coordinates Xmin and Ymin, respectively, and “Xe+Xf” and “Ye” are input as the maximum coordinates Xmax and Ymax, respectively.

The first determination section 111 determines whether the internal coordinates (Xi, Yi) have deviated from a nontransition area Ri defined between the minimum coordinates and the maximum coordinates. As illustrated in FIG. 7, the nontransition area Ri is defined as [Xmin+α˜Xmax−α] n [Ymin+α˜Ymax−α].

The value “a” is a threshold value at which the internal coordinates (Xi, Yi) correspond to an end of the display area of the internal display 14 or the external display 17. Specifically, if the internal coordinates (Xi, Yi) do not deviate from the nontransition area Ri, it is determined that the internal coordinates (Xi, Yi) are not located at an end of the display area of the internal display 14 or the external display 17, and if the internal coordinates (Xi, Yi) deviate from the nontransition area Ri, it is determined that the internal coordinates (Xi, Yi) are located at an end of the display area of the internal display 14 or the external display 17. Examples of the value “α” include 0 and any natural number.

The second determination section 112 determines whether a first coordinate, Xmin−α, smaller than the minimum coordinate Xmin is included in the internal-coordinate space managed by the OS 20 if the internal coordinate Xi has deviated from the nontransition area Ri to the minimum coordinate Xmin side. Similarly, the second determination section 112 determines whether a first coordinate, Ymin−α, smaller than the minimum coordinate Ymin is included in the internal-coordinate space managed by the OS 20 if the internal coordinate Yi has deviated from the nontransition area Ri to the minimum coordinate Ymin side. Furthermore, the second determination section 112 determines whether a second coordinate, Xmax+α, larger than the maximum coordinate Xmax is included in the internal-coordinate space managed by the OS 20 if the internal coordinate Xi has deviated from the coordinate range Ri to the maximum coordinate Xmax side. Similarly, the second determination section 112 determines whether a second coordinate, Ymax+α, larger than the maximum coordinate Ymax is included in the internal-coordinate space managed by the OS 20 if the internal coordinate Yi has deviated from the coordinate range Ri to the maximum coordinate Ymax side.

The fact that the first coordinate, Xmin−α, smaller than the minimum coordinate Xmin is included in the internal-coordinate space indicates that an internal-coordinate space is present also at the left of the target display, that is, another display is present at the left of the target display.

The fact that the first coordinate, Ymin−α, smaller than the minimum coordinate Ymin is included in the internal-coordinate space indicates that an internal-coordinate space is present also above the target display, that is, another display is present above the target display.

The fact that the second coordinate, Xmax+α, larger than the maximum coordinate Xmax is included in the internal-coordinate space indicates that an internal-coordinate space is present also at the right of the target display, that is, another display is present at the right of the target display.

The fact that the second coordinate, Ymax+α, larger than the maximum coordinate Ymax is included in the internal-coordinate space indicates that an internal-coordinate space is present also below the target display, that is, another display is present below the target display.

If the first coordinate, Xmin−α, is a coordinate managed by the OS 20, the coordinate replacing section 113 sets the first coordinate, Xmin−α, as the display coordinate Xd of the cursor C. Similarly, if the first coordinate, Ymin−α, is a coordinate managed by the OS 20, the coordinate replacing section 113 sets the first coordinate, Ymin−α, as the display coordinate Yd of the cursor C. Furthermore, if the second coordinate, Xmax+α, is a coordinate managed by the OS 20, the coordinate replacing section 113 sets the second coordinate, Xmax+α, as the display coordinate Xd of the cursor C. Similarly, if the second coordinate, Ymax+α, is a coordinate managed by the OS 20, the coordinate replacing section 113 sets the second coordinate, Ymax+α, as the display coordinate Yd of the cursor C.

The identification-information update section 114 inverts the CD value stored in the first storage section 107 if the first coordinates or the second coordinates are set as display coordinates by the coordinate replacing section 113.

The fourth storage section 115 stores the minimum coordinates (Xmin, Ymin) and the maximum coordinates (Xmax, Ymax) of at least one of the internal display 14 and the external display 17 stored in the HDD 16.

The input section 110, the first determination section 111, the second determination section 112, the coordinate replacing section 113, and the identification-information update section 114 are individually implemented by the CPU 11 on the basis of the OS 20 and the device drivers 21, 22, and 23 loaded in the main memory 12. The fourth storage section 115 is configured in the main memory 12.

Second Determination Process P2

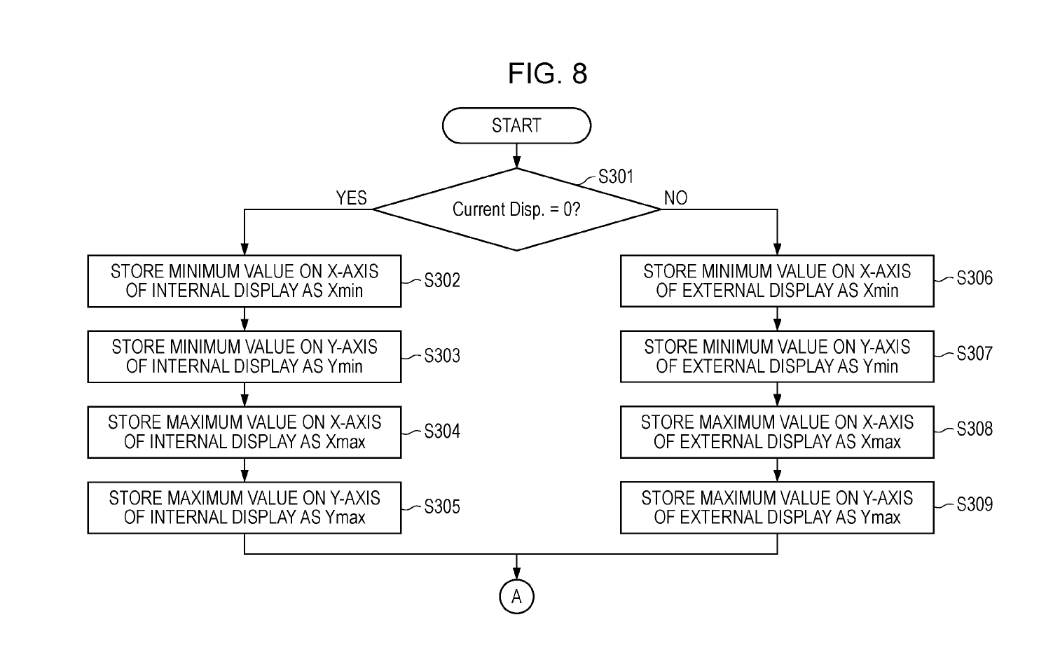

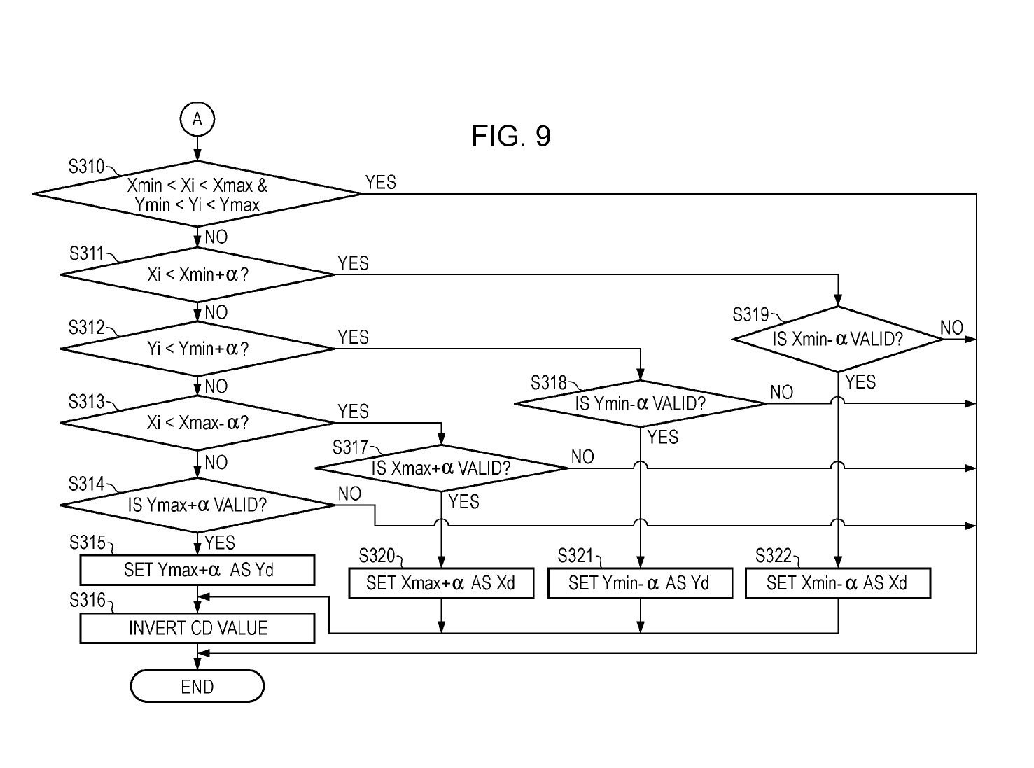

Referring to FIGS. 8 and 9, the second determination process P2 for determining the display coordinates (Xd, Yd) of the cursor C on the basis of the internal coordinates (Xi, Yi) determined by the first determination process P1 will be described.

FIGS. 8 and 9 are flowcharts for the second determination process P2 for determining the display coordinates (Xd, Yd) of the cursor C according to the first embodiment.

After the internal coordinates (Xi, Yi) are determined by the first determination process P1, the second process P2 for determining the display coordinates (Xd, Yd) of the cursor C is started, as illustrated in FIG. 8.

When the second determination process P2 is started, the input section 110 determines whether the CD value stored in the first storage section 107 is “0” or “1” (step S301).

If the CD value is “0”, the input section 110 stores the minimum coordinate “0” on the X-axis of the internal display 14 as Xmin in the fourth storage section 115 (step S302).

Similarly, the input section 110 stores the minimum coordinate “0” on the Y-axis of the internal display 14, the maximum coordinate “Xe” on the X-axis, and the maximum coordinate “Ye” on the Y-axis as Ymin, Xmax, and Ymax, respectively, in the fourth storage section 115 (steps S303, S304, and S305).

On the other hand, if the CD value is “1”, the input section 110 stores the minimum coordinate “Xe+1” on the X-axis of the external display 17 as Xmin in the fourth storage section 115 (step S306).

Similarly, the input section 110 stores the minimum coordinate “0” on the Y-axis of the external display 17, the maximum coordinate “Xe+Xf” on the X-axis, and the maximum coordinate “Ye” on the Y-axis as Ymin, Xmax, and Ymax, respectively, in the fourth storage section 115 (steps S307, S308, and S309).

Next, as illustrated in FIG. 9, the first determination section 111 determines whether the internal coordinates (Xi, Yi) are included in the nontransition area Ri ([Xmin+α˜Xmax−α] n [Ymin+α˜Ymax−α]) (step S310).

If the internal coordinates (Xi, Yi) are included in the nontransition area Ri (Yes in step S310), the coordinate replacing section 113 sets the internal coordinates (Xi, Yi) as the display coordinates (Xd, Yd). Thus, the second determination process P2 concludes.

If the internal coordinates (Xi, Yi) are not included in the nontransition area Ri (No in step S310), the second determination section 112 determines whether the internal coordinate Xi is smaller than Xmin+α (step S311).

If the internal coordinate Xi is smaller than Xmin+α (Yes in step S311), the second determination section 112 determines whether the first coordinate, Xmin−α, is included in the coordinate space managed by the OS 20 (step S319).

If the first coordinate, Xmin−α, is a coordinate managed by the OS 20 (Yes in step S319), the coordinate replacing section 113 sets the first coordinate, Xmin−α, as the display coordinate Xd (step S322) and sets the internal coordinate Yi as the display coordinate Yd. Thus, the display coordinates (Xd, Yd)=(Xmin−α, Yi) holds. Subsequently, the identification-information update section 114 inverts the CD value stored in the first storage section 117 (step S316). Thus, the second determination process P2 concludes.

If the first coordinate, Xmin−α, is not a coordinate managed by the OS 20 (No in step S319), the coordinate replacing section 113 sets the internal coordinate Xi as the display coordinate Xd and sets the internal coordinate Yi as the display coordinate Yd. Thus, the display coordinates (Xd, Yd)=(Xi, Yi) (=internal coordinates as they are) holds. Thus, the second determination process P2 concludes.

If the internal coordinate Xi is equal to or greater than Xmin+α (No in step S311), the second determination section 112 determines whether the internal coordinate Yi is smaller than Ymin+α (step S312).

If the internal coordinate Yi is smaller than Ymin+α (Yes in step S312), the second determination section 112 determines whether the first coordinate, Ymin−α, is included in the coordinate space managed by the OS 20 (step S318).

If the first coordinate, Ymin−α, is a coordinate managed by the OS 20 (Yes in step S318), the coordinate replacing section 113 sets the first coordinate, Ymin−α, as the display coordinate Yd (step S321) and sets the internal coordinate Xi as the display coordinate Xd. Thus, the display coordinates (Xd, Yd)=(Xd, Ymin−α) holds. Subsequently, the identification-information update section 114 inverts the CD value stored in the first storage section 117 (step S316). Thus, the second determination process P2 concludes.

If the first coordinate, Ymin−α, is not a coordinate managed by the OS 20 (No in step S318), the internal coordinate Yi is set as the display coordinate Yd, and the internal coordinate Xi is set as the display coordinate Xd. Thus, the display coordinates (Xd, Yd)=(Xi, Yi) (=internal coordinates as they are) holds. Thus, the second determination process P2 concludes.

If the internal coordinate Yi is equal to or greater than Ymin+α (No in step S312), the second determination section 112 determines whether the internal coordinate Xi is smaller than Xmax−α (step S313).

If the internal coordinate Xi is smaller than Xmax−α (Yes in step S313), the second determination section 112 determines whether the second coordinate, Xmax+α, is included in the coordinate space managed by the OS 20 (step S317).

If the second coordinate, Xmax+α, is a coordinate managed by the OS 20 (Yes in step S317), the coordinate replacing section 113 sets the second coordinate, Xmax+α, as the display coordinate Xd (step S320) and sets the internal coordinate Yi as the display coordinate Yd. Thus, the display coordinates (Xd, Yd)=(Xmax+α, Yi) holds. Subsequently, the identification-information update section 114 inverts the CD value stored in the first storage section 117 (step S316). Thus, the second determination process P2 concludes.

If the second coordinate, Xmax+α, is not a coordinate managed by the OS 20 (No in step S317), the coordinate replacing section 113 sets the internal coordinate Xi as the display coordinate Xd and sets the internal coordinate Yi as the display coordinate Yd. Thus, the display coordinates (Xd, Yd)=(Xi, Yi) (=internal coordinates as they are) holds. Thus, the second determination process P2 is concluded.

If the internal coordinate Xi is equal to or greater than Xmax−α (No in step S313), it is determined whether the second coordinate, Ymax+α, is included in the coordinate space managed by the OS 20 (step S314).

If the second coordinate, Ymax+α, is a coordinate managed by the OS 20 (Yes in step S314), the coordinate replacing section 113 sets the internal coordinate Yi as the second coordinate, Ymax+α, (step S315) and sets the internal coordinate Xi as the display coordinate Xd. Thus, the display coordinates (Xd, Yd)=(Xi, Ymax+α) holds. Subsequently, the identification-information update section 114 inverts the CD value stored in the first storage section 117 (step S316). Thus, the second determination process P2 concludes.

If the second coordinate, Ymax+α, is not a coordinate managed by the OS 20 (No in step S314), the internal coordinate Yi is set as the display coordinate Yd, and the internal coordinate Xi is set as the display coordinate Xd. Thus, the display coordinates (Xd, Yd)=(Xi, Yi) (=internal coordinates as they are) holds. Thus, the second determination process P2 concludes.

The second determination process P2 is executed, for example, every time the cursor C is operated by the user, so that the internal coordinates (Xi, Yi) change, in which the display coordinates (Xd, Yd) of the cursor C are determined in sequence. When the display coordinates (Xd, Yd) are determined, the display control unit 101 outputs an instruction to display an image to either of the graphics controllers 13a and 13b. Thus, the cursor C is displayed on either of the internal display 14 and the external display 17.

Cursor Display Operation

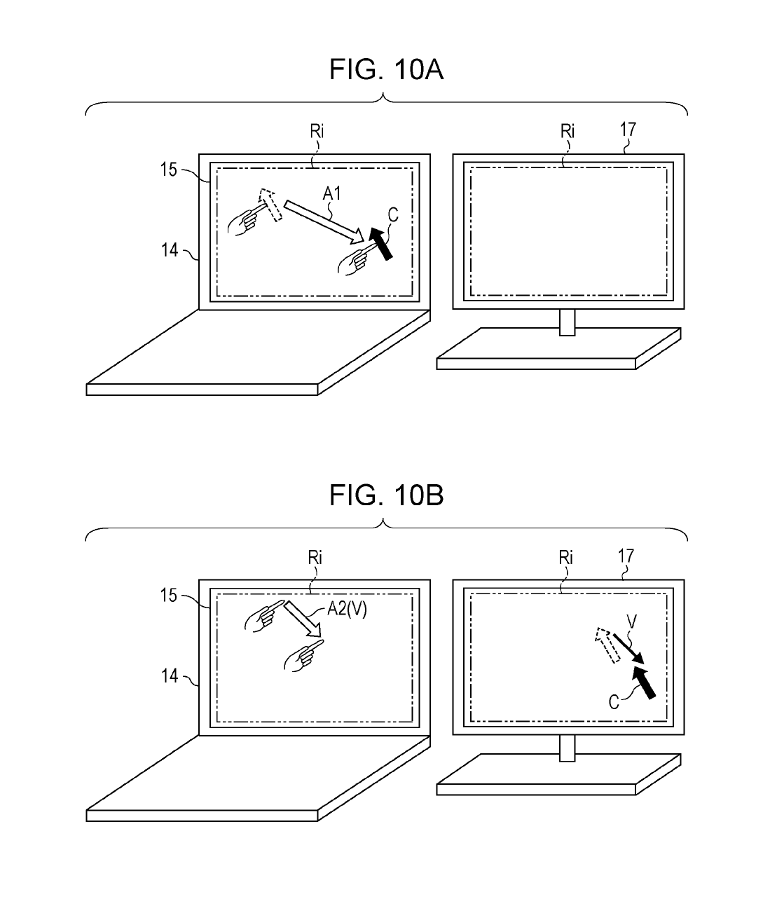

Referring to FIGS. 10A and 10B, the operation of displaying the cursor C by the first determination process P1 will be described.

FIGS. 10A and 10B are explanatory diagrams illustrating an operation for displaying the cursor C according to the first embodiment.

The following description is made on the assumption that the internal coordinates (Xi, Yi) are included in the nontransition area Ri. The dotted arrows in FIGS. 10A and 10B indicate the cursor C before being moved, and the solid arrows indicate the cursor C after being moved.

As illustrated in FIG. 10A, when the fingertip in contact with the touch panel 15 is moved (see arrow A1) while the cursor C is displayed on the internal display 14, the cursor C moves in the display area of the internal display 14 so as to follow the position of the fingertip. That is, the cursor C moves in the display area of the internal display 14 so as to be displayed directly under the fingertip.

On the other hand, as illustrated in FIG. 10B, when the fingertip in contact with the touch panel 15 is moved (see arrow A2) while the cursor C is displayed on the external display 17, the cursor C moves in the display area of the external display 17 so as to follow the movement of the fingertip, with the initial display position (see the dotted arrow) as the starting point. That is, the cursor C moves so as to follow the displacement vector V (=fingertip moving vector).

Cursor Moving Operation

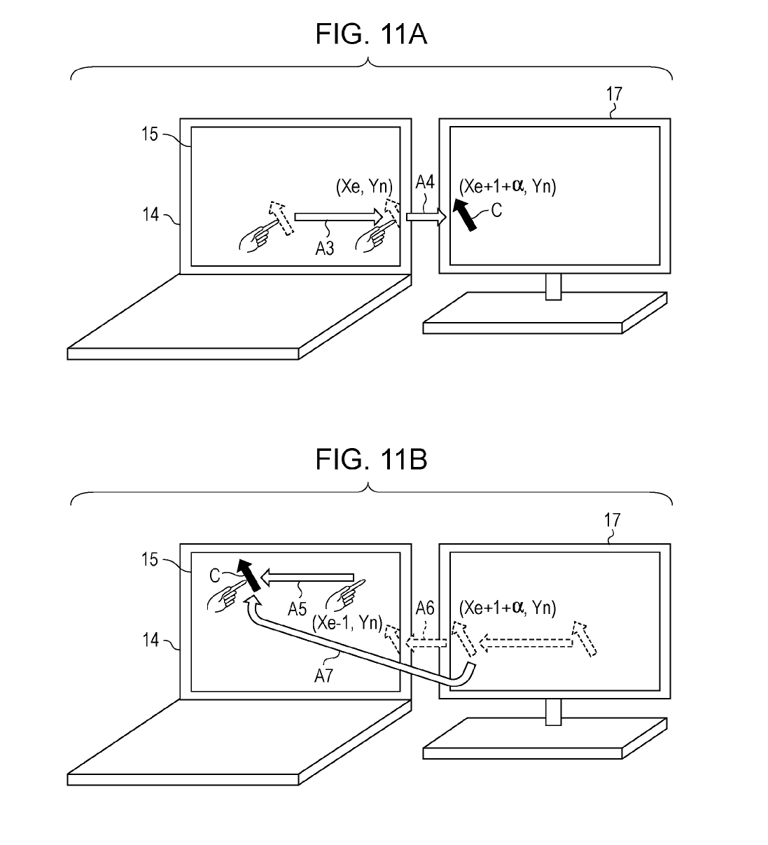

Referring to FIGS. 11A and 11B, the operation of moving the cursor C by the second determination process P2 will be described.

The following description is made on the assumption that the internal coordinates (Xi, Yi) are included in the nontransition area Ri by default. The dotted arrows in FIGS. 11A and 11B indicate the cursor C before being moved, and the solid arrows indicate the cursor C after being moved.

FIGS. 11A and 11B are explanatory diagrams illustrating an operation for moving the cursor C according to the first embodiment.

As illustrated in FIG. 11A, when the internal coordinate Xi deviates from the nontransition area Ri of the internal display 14 to the maximum coordinate “Xe” side, that is, the internal coordinate Xi becomes larger than “Xe−α”, by, for example, the user moving the fingertip (see arrow A3), the cursor C moves from the internal display 14 to the external display 17 (arrow A4). At that time, the display coordinate Xd of the cursor C becomes “Xe+1+α”, and the display coordinate Yd of the cursor C becomes the coordinate “Yn” of the cursor C directly before the cursor C jumps to the external display 17.

On the other hand, as illustrated in FIG. 11B, when the internal coordinate Xi deviates from the nontransition area Ri of the external display 17 to the minimum value “Xe+1” side, that is, the internal coordinate Xi becomes smaller than “Xe+1+α”, by, for example, the user moving the fingertip (arrow A5), the cursor C moves from the external display 17 to the internal display 14 (arrow A6). At that time, the display coordinate Xd of the cursor C becomes “Xe−α”, and the display coordinate Yd of the cursor C becomes the coordinate Yn of the cursor C directly before the cursor C jumps to the internal display 14. However, since the first determination process P1 is called when the cursor C is operated, the cursor C moves to right under the fingertip directly after moving to the internal display 14. Therefore, the cursor C moves visually as indicated by arrow A7.

Although it is assumed that the external display 17 is disposed at the right of the internal display 14, the first embodiment is not limited thereto. For example, the external display 17 may be disposed at the left of, above, or below the internal display 14. In any placement, the system for moving the cursor C between the internal display 14 and the external display 17 is the same.

As described above, according to the first embodiment, the system for determining the display coordinates (Xd, Yd) of the cursor C is switched depending on a display (either of the internal display 14 and the external display 17) on which the cursor C is displayed.

Specifically, when the cursor C is to be displayed on the external display 17, the cursor C is controlled so that it follows the movement of the fingertip using the displacement vector V of the detected coordinates (Xp, Yp) on the touch panel 15.

This allows the cursor operation in the display area of the external display 17 to be achieved using the touch panel 15 affixed to the internal display 14. Therefore, an external mouse or the like is not connected even if an external display is connected to, for example, a personal computer that uses only a touch panel as an input device to achieve a so-called multidisplay system.

Moreover, cursor control in the display area of the external display 17 can be achieved irrespective of the difference in size between the internal display 14 and the external display 17.

Furthermore, according to the first embodiment, when the cursor C is moved close to an end of the internal display 14, it is determined that the user intends to move the cursor C to the external display 17, and thus, the cursor C is moved from the internal display 14 to the external display 17. Similarly, when the cursor C is moved close to an end of the external display 17, it is determined that the user intends to move the cursor C to the internal display 14, so that the cursor C is moved from the external display 17 to the internal display 14.

Therefore, the user can move the cursor C to the internal display 14 or the external display 17 seamlessly only by moving the fingertip intuitively to move the cursor C.

### Second Embodiment

A second embodiment will be descried hereinbelow. However, the same configuration, operation, and advantages as those of the first embodiment will be omitted.

In the first embodiment, if the cursor C is displayed on the external display 17, the internal coordinates (Xi, Yi) are determined by using the displacement vector V of the detected coordinates (Xp, Yp) on the touch panel 15. In contrast, in the second embodiment, if the cursor C is displayed on the external display 17, the internal coordinates (Xi, Yi) are determined using only the detected coordinates (Xp, Yp) on the touch panel 15. That is, the second embodiment does not use the displacement vector V.

Functional Block for Cursor Control

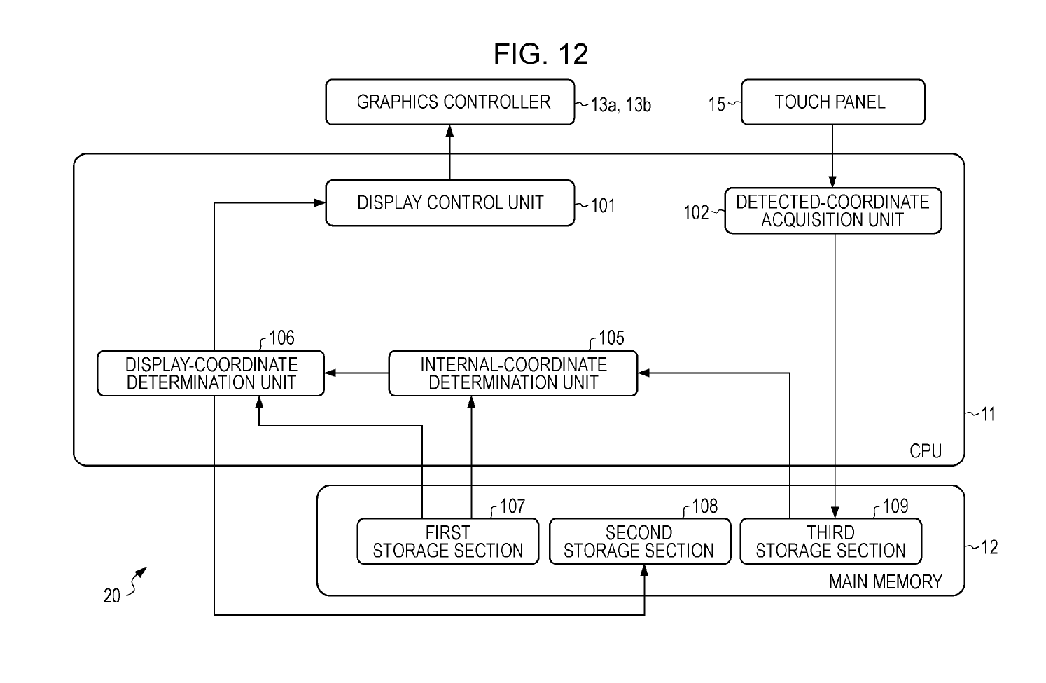

Referring to FIG. 12, a functional block for determining the internal coordinates (Xi, Yi) on the basis of the detected coordinates (Xp, Yp) acquired from the touch panel 15 will be described.

FIG. 12 is a functional block diagram of cursor control according to the second embodiment.

As illustrated in FIG. 12, a personal computer 20 according to the second embodiment does not include the displacement-vector calculating unit 104 according to the first embodiment.

The internal-coordinate determination unit 105 determines the internal coordinates (Xi, Yi) on the basis of the CD value stored in the first storage section 107 and the latest detected coordinates (Xp, Yp) stored in the third storage section 109.

First Determination Process P1′

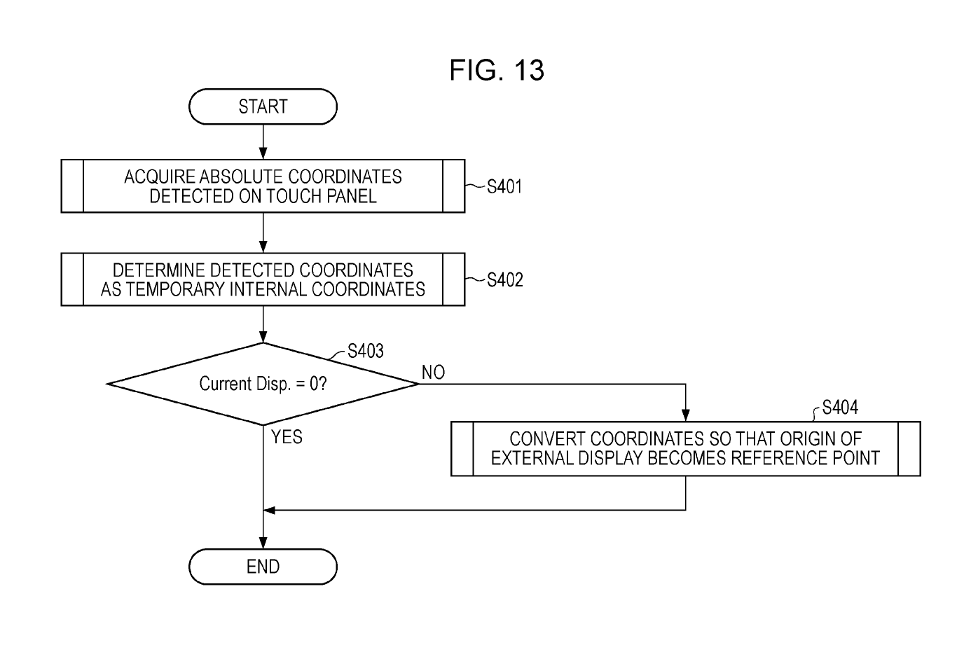

Referring to FIG. 13, a first determination process P1′ for determining the internal coordinates (Xi, Yi) on the basis of the detected coordinates (Xp, Yp) acquired from the touch panel 15 will be described.

FIG. 13 is a flowchart for the first determination process P1′ for determining the internal coordinates (Xi, Yi) according to the second embodiment.

For example, when the cursor C is operated by a user's fingertip to cause an interrupt or the like, the first process P′ for determining the internal coordinates (Xi, Yi) is started, as illustrated in FIG. 13.

When the first determination process P1′ is started, the detected-coordinate acquisition unit 102 starts acquisition of the detected coordinates (Xp, Yp) detected on the touch panel 15 (step S401). The detected coordinates (Xp, Yp) acquired by the detected-coordinate acquisition unit 102 are stored in the third storage section 109 one after another.

Next, the internal-coordinate determination unit 105 determines the latest detected coordinates (Xp, Yp) stored in the third storage section 109 as temporary internal coordinates (Xi′, Yi′) (step S402).

Next, the internal-coordinate determination unit 105 determines whether the CD value stored in the first storage section 107 is “0” or “1” (step S403). That is, the internal-coordinate determination unit 105 determines on which of the internal display 14 or the external display 17 the cursor C is displayed.

If it is determined that the CD value is “0” (Yes in step S403), the internal-coordinate determination unit 105 determines the temporary internal coordinates (Xi′, Yi′) as the internal coordinates (Xi, Yi). That is, the internal coordinates (Xi, Yi)=(Xi′, Yi′) holds. Thus, the first determination process P1′ concludes.

If it is determined that the CD value is “1” (No in step S403), the internal-coordinate determination unit 105 adds the minimum coordinates (Xe+1, 0) of the external display 17 to the temporary internal coordinates (Xi′, Yi′) and sets them as the internal coordinates (Xi, Yi) (step S404). Specifically, the internal coordinates (Xi, Yi)=(Xi′+Xe+1, Yi′) holds. Thus, the first determination process P1 concludes.

Cursor Display Operation

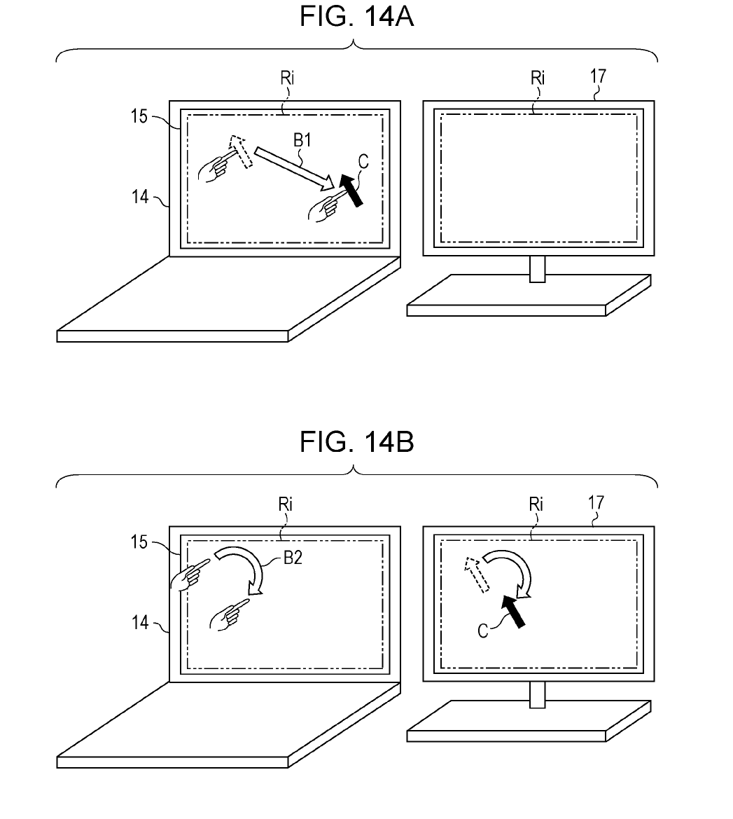

Referring to FIGS. 14A and 14B, the operation of displaying the cursor C by the first determination process P1′ will be described.

FIGS. 14A and 14B are explanatory diagrams illustrating the operation of displaying the cursor C according to the second embodiment.

The following description is made on the assumption that the internal coordinates (Xi, Yi) are included in the nontransition area Ri. The dotted arrows in FIGS. 14A and 14B indicate the cursor C before being moved, and the solid arrows indicate the cursor C after being moved.

As illustrated in FIG. 14A, when the fingertip in contact with the touch panel 15 is moved (see arrow B1) while the cursor C is displayed on the internal display 14, the cursor C moves in the display area of the internal display 14 so as to follow the position of the fingertip. That is, the cursor C moves in the display area of the internal display 14 so as to be displayed directly under the fingertip.

On the other hand, as illustrated in FIG. 14B, when the fingertip in contact with the touch panel 15 is moved (see arrow B2) while the cursor C is displayed on the external display 17, the cursor C moves in the display area of the external display 17 so as to follow the movement of the fingertip. That is, the cursor C moves in the display area of the external display 17 so as not to move directly under the fingertip but to follow the movement of the fingertip.

Cursor Moving Operation

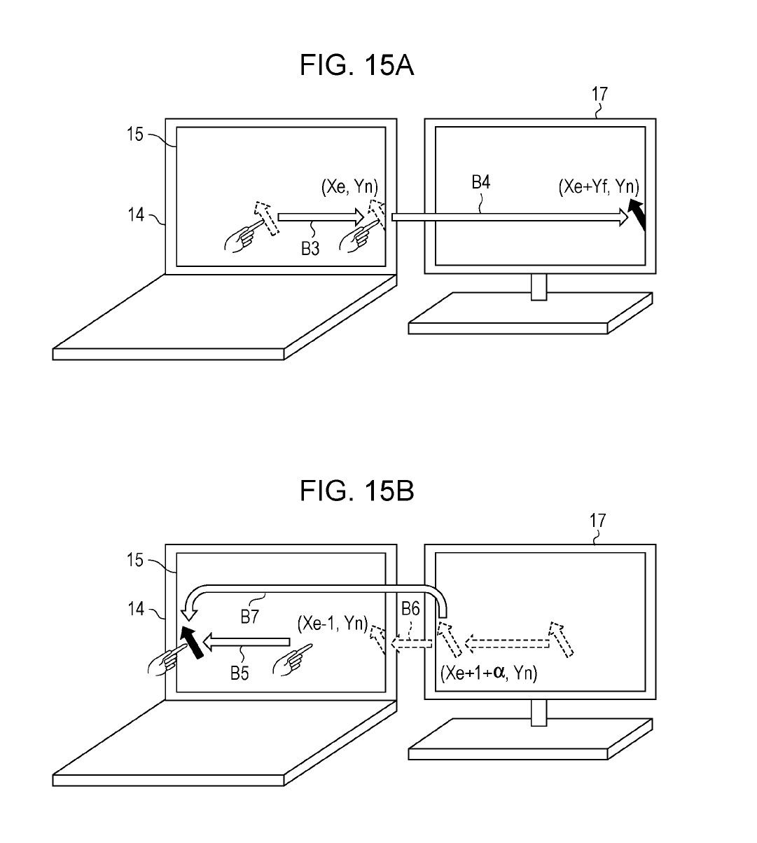

Referring to FIGS. 15A and 15B, the operation of moving the cursor C by the second determination process P2 will be described.

FIGS. 15A and 15B are explanatory diagrams illustrating the operation of moving the cursor C according to the second embodiment.

Although the second determination process P2 according to the second embodiment is the same as that of the first embodiment, the first determination process P1′ according to the second embodiment differs from that of the first embodiment. Therefore, the operation of moving the cursor C differs between the first and second embodiments.

As illustrated in FIG. 15A, when the internal coordinate Xi deviates from the nontransition area Ri of the internal display 14 to the maximum coordinate “Xe” side, that is, the internal coordinate Xi becomes larger than “Xe−α” by, for example, the user moving the fingertip (see arrow B3), the cursor C moves from the internal display 14 to the external display 17 (arrow B4). At that time, the display coordinate Xd of the cursor C becomes “Xe+Xf”, and the display coordinate Yd of the cursor C becomes the coordinate “Yn” directly before the cursor C jumps to the external display 17. That is, the cursor C that has moved to the external display 17 is displayed at the right end of the external display 17. Therefore, the relative position of the fingertip on the internal display 14 corresponds to the relative position on the external display 17. This can therefore reduce, for example, losing sight of the cursor C directly after the cursor C is moved from the internal display 14 to the external display 17.

On the other hand, as illustrated in FIG. 15B, when the internal coordinate Xi deviates from the nontransition area Ri of the external display 17 to the minimum value “Xe+1” side, that is, the internal coordinate Xi becomes smaller than “Xe+1+α” by, for example, the user moving the fingertip (arrow B5), the cursor C moves from the external display 17 to the internal display 14 (arrow B6). At that time, the display coordinate Xd of the cursor C becomes “Xe−α”, and the display coordinate Yd of the cursor C becomes the coordinate Yn of the cursor C. However, since the first determination process P1′ is called when the cursor C is operated, as in the first embodiment, the cursor C moves to right under the fingertip directly after moving to the internal display 14. Therefore, the cursor C moves visually as indicated by arrow B7.

According to the second embodiment, when the cursor C is to be displayed on the external display 17, the final internal coordinates (Xi, Yi) are determined so that the cursor C is displayed on the external display 17 by determining the temporary internal coordinates (Xi′, Yi′) on the basis of the detected coordinates (Xp, Yp) on the touch panel 15 and thereafter adding the minimum coordinates (Xe+1, 0) of the external display 17 to the temporary internal coordinates (Xi′, Yi′)

This allows a cursor operation in the display area of the external display 17 to be achieved using the touch panel 15 affixed to the internal display 14. Therefore, an external mouse or the like is not connected even if an external display is connected to, for example, a personal computer that uses only a touch panel as an input device to achieve a so-called multidisplay system.

Moreover, since the cursor C that has moved from the internal display 14 to the external display 17 is displayed at the right end of the external display 17, the relative position of the fingertip on the internal display 14 corresponds to the relative position of the cursor C on the external display 17. This can reduce, for example, losing sight of the cursor C directly after the cursor C is moved from the internal display 14 to the external display 17.

Although it is assumed that the external display 17 is disposed at the right of the internal display 14, the second embodiment is not limited thereto. For example, the external display 17 may be disposed at the left of, above, or below the internal display 14. In any placement, the system for moving the cursor C between the internal display 14 and the external display 17 is the same.

Various programs for use in the first and second embodiments may be stored in a portable storage medium in circulation on the market. In this case, the portable storage medium may se loaded in a reading device, from which the programs may be read and implemented by the CPU 11. Examples of the portable storage medium include various types of storage medium, such as a CD-ROM, a flexible disk, an optical disk, a magnetooptical disk, an IC card, and a USB memory.

Although the first and the second embodiments use the CPU 11, the embodiments are not limited thereto. For example, a processing circuit, such as a micro processing unit (MPU) or a field programmable gate array (FPGA), may be used instead of the CPU 11.

The coordinate systems according to the first and second embodiments are not limited to the X-axis and the Y-axis perpendicular to each other, and the origin does not have to be the upper left corner. Disclosed in the first and second embodiments are merely examples.

In the first and second embodiments, although cursor movement between the internal display 14 and the external display 17 has been described, the embodiments are not limited thereto. For example, the embodiments may be applied to cursor movement among three or more displays. For the cursor movement among three or more displays, values other than “0” and “1” may be prepared as the CD value.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A cursor control apparatus which manages a virtual-coordinate space including a first display area of a first display and a second display area of a second display continuous with each other and which displays a cursor on either of the first display area and the second display area, the cursor control apparatus comprising:
a memory that stores a display coordinate at which the cursor is displayed, the display coordinate being defined in the virtual-coordinate space; and
a processor that executes a process including
acquiring a touched coordinate at which a touch panel on the first display area is touched,
calculating a displacement vector of the touched coordinate,
identifying which is a display area displaying the cursor among the first display area and the second display area, and
updating the display coordinate with a coordinate corresponding to the touched coordinate when the cursor is determined to be displayed in the first display area, and updating the display coordinate with a coordinate displaced from the display coordinate stored in the memory using the displacement vector when the cursor is determined to be displayed in the second display area.

2. The cursor control apparatus according to claim 1, wherein
the memory further stores
identification information that indicates which is the display area including the display coordinate among the first display area and the second display area,
a minimum coordinate and a maximum coordinate of the first display area, and
a minimum coordinate and a maximum coordinate of the second display area;
the identifying includes identifying which is the display area displaying the cursor among the first display area and the second display area on a basis of the identification information stored in the memory; and
the updating includes
determining whether the display coordinate of the cursor is included in a first area of the first display area or a second area of the second display area on a basis of the minimum coordinate and the maximum coordinate of the first display area or the minimum coordinate and the maximum coordinate of the second display area stored in the memory, and
updating the display coordinate with a coordinate in the second display area when the display coordinate is determined to be included in the first area, and updating the display coordinate with a coordinate in the first display area when the display coordinate is determined to be included in the second area.

3. The cursor control apparatus according to claim 2, wherein
the replacing includes
updating the identification information stored in the memory when the display coordinate is replaced with the coordinate in the first display area or the coordinate in the second display area.

4. A cursor control apparatus which manages a virtual-coordinate space including a first display area of a first display and a second display area of a second display continuous with each other and which displays a cursor on either of the first display area and the second display area, the cursor control apparatus comprising:
a memory that stores identification information that indicates which is a display area including a display coordinate at which the cursor is displayed among the first display area and the second display area, the display coordinate being defined in the virtual-coordinate space; and
a processor that executes a process including determining the display coordinate on a basis of an input coordinate input from a touch panel on the first display area and the identification information stored in the memory.

5. The cursor control apparatus according to claim 4, wherein
the memory further stores the display coordinate; and
the determining includes
calculating a displacement vector of the input coordinate, and
updating the display coordinate with a coordinate corresponding to the input coordinate when the display coordinate is determined to be included in the first display area, and updating the display coordinate with a coordinate displaced from the display coordinate stored in the memory using the displacement vector when the display coordinate is determined to be included in the second display area.

6. The cursor control apparatus according to claim 4, wherein
the determining includes
updating the display coordinate with a coordinate corresponding to the input coordinate when the display coordinate is included in the first display area, and updating the display coordinate with a coordinate obtained by adding a coordinate corresponding to the input coordinate to a coordinate corresponding to a reference position defined in the second display area when the display coordinate is included in the second display area.

7. A cursor control method that manages a virtual-coordinate space including a first display area of a first display and a second display area of a second display continuous with each other and displays a cursor on either of the first display area and the second display area, the cursor control method comprising:
storing a display coordinate at which the cursor is displayed in a memory, the display coordinate being defined in the virtual-coordinate space;
acquiring a touched coordinate at which a touch panel on the first display area is touched;
calculating a displacement vector of the touched coordinate; and
identifying which is a display area displaying the cursor among the first display area and the second display area, and
updating, by a computer, the display coordinate with a coordinate corresponding to the touched coordinate when the cursor is determined to be displayed in the first display area, and updating, by a computer, the display coordinate with a coordinate displaced from the display coordinate stored in the memory using the displacement vector when the cursor is determined to be displayed in the second display area.

8. A computer-readable storage medium for storing a cursor control program which manages a virtual-coordinate space including a first display area of a first display and a second display area of a second display continuous with each other and which displays a cursor on either of the first display area and the second display area, the cursor control program causes a computer to execute a process including:
storing a display coordinate at which the cursor is displayed in a memory, the display coordinate being defined in the virtual-coordinate space;
acquiring a touched coordinate at which a touch panel on the first display area is touched;
calculating a displacement vector of the touched coordinate; and
identifying which is a display area displaying the cursor among the first display area and the second display area, and
updating the display coordinate with a coordinate corresponding to the touched coordinate when the cursor is determined to be displayed in the first display area, and updating the display coordinate with a coordinate displaced from the display coordinate stored in the memory using the displacement vector when the cursor is determined to be displayed in the second display area.
